(19) United States
(12) Patent Application Publication
(10) Pub. No.: US 2008/0278416 A1
(43) Pub. Date: Nov. 13, 2008

(54) Multiple grayscale display method and apparatus

(76) Inventors: Shunji Ohta, Yokohama (JP); Shinsuke Tanaka, Fujisawa (JP); Yuichiro Kimura, Yokohama (JP)

Correspondence Address: MCDERMOTT WILL & EMERY LLP, 600 13TH STREET, N.W., WASHINGTON, DC, 20005-3096, US

(21) Appl. No.: 11/812,241

(22) Filed: Jun. 15, 2007

(30) Foreign Application Priority Data
Sep. 28, 2006 (JP) JP2006-265482

(51) Int. Cl. G09G 3/28

(52) U.S. Cl. 345/63; 345/690

(57) ABSTRACT

In a PDP apparatus (multiple grayscale display apparatus), an technique for reducing the unevenness of the electric charge states between cells and the background emission by the reset discharge, and also reducing the false outline, therefore, the image quality can be improved, and the drive can be stabilized is provided. In a multiple grayscale display method by sub field method, a structure in which as a sub field lighting pattern, in only specified sub fields (example: SF3, SF9), light-off sub fields in halfway of continuous light-on sub fields are permitted, is employed. Thereby, the unevenness of the electric charge states between cells is reduced and omission of reset discharge becomes easy, since the number of light-off in halfway is small, the false outlines is reduced.

### CROSS-REFERENCE TO RELATED APPLICATION

The present application claims priority from Japanese Patent Application No. JP 2006-265482 filed on Sep. 28, 2006, the content of which is hereby incorporated by reference into this application.

### TECHNICAL FIELD OF THE INVENTION

The present invention relates to an art of multiple grayscale display processing for displaying multiple grayscale moving images, in a plasma display apparatus (PDP apparatus) having a plasma display panel (PDP) and the like, more particularly to sub field conversion and sub field light-on patterns in sub field method (frame time-division display method).

### BACKGROUND OF THE INVENTION

In a PDP apparatus, multiple grayscale moving images are displayed on a PDP using the sub field method. In the sub field method, a field (or a frame), that is an the image display unit, displayed on a display panel (PDP) is structured in a time-division manner into a plurality of sub fields (or sub frames) weighted corresponding to luminance (brightness) in light-on state are assigned. And, by selective lighting states of a combination of light-on (ON)/light-off (OFF) of the sub fields in the field, the grayscale in cells of the field and pixels corresponding thereto is expressed.

In the sub field conversion processing (multiple grayscale display processing), on the basis of the display data (video signals) of input, display data (field and sub field data) expressing the grayscale levels (grayscale values) of multiple grayscale in each display cells/pixels of the field is output. The grayscale values are coded to lighting steps by predetermined sub field selective lighting states, according to a sub field lighting pattern (referred to as a sub field conversion table also). The sub field lighting pattern regulates the relation of correspondence between the combination of selective lighting of a plurality of sub fields to which each weighting level of the field is assigned, and the lighting steps corresponding to the grayscale values. Note that, the lighting steps are corresponded to the grayscale values, but are different therefrom.

Further, in the PDP apparatus, since the sub field method (frame time-division display method) is used, a peculiar phenomenon called a false outline (pseudo outline) occurs, and deteriorates a quality of the display. As the source generating the false outline, a light-off sub field (lack of lighting sub field) that exists in halfway of continuous lighting sub fields in the lighting steps of the sub field lighting pattern is considered. In FIG. 10, the sub field lighting pattern in the structure of binary coding method is shown.

As the conventional method that is thought to have the largest effect as the countermeasure against the false outline, a first method shown below exists. As the first method, in the case where one field is structured of m pieces of sub fields (SF1 to SFm), as a structure of the sub field lighting pattern, a structure in which the number of the lighting steps (s: step) is set to m+1, and when the number of the lighting steps is increased by one, the number of the lighting sub fields are increased by one, is employed. Thereby, the lack of lighting sub fields, which is the source generating the false outline, is eliminated. In FIG. 11, an example of the sub field lighting pattern by the first method is shown. The first method is described in Japanese Patent No. 3322809 (Patent Document 1) and the like. However, in the first method, since the lack of the lighting sub fields is eliminated simply, the grayscale expression (the number of lighting steps (s)) becomes in short. For example, in general, the number (m pieces) of sub fields in the case where the field display is at 60 Hz is often around 10, and in that case, according to the first method, just only 11 lighting steps (s) can be obtained.

Further, as the conventional method that can secure the grayscale expression sufficiently, and is used widely, a second method shown below exists. As the second method, as a structure of the sub field lighting pattern, a structure in which at some of all the lighting steps (s), a lighting step (S) where only one sub field is made a lack in the course of continuous lighting sub fields is arranged, is employed. In this structure, the lack in the lighting steps (s) is limited to one portion. In this case, the number of the lighting steps (s) increases, which is advantageous for the grayscale expression. However, although the false outline can be reduced compared to the structure of the binary coding method (FIG. 10), the portion of the lighting step (s) where the lack of lighting sub field exists becomes the source generating the false outline. In FIG. 12, an example of the sub field lighting pattern in the second method is shown.

### SUMMARY OF THE INVENTION

In the structure of the sub field lighting pattern in the conventional PDP apparatus, the positions of light-off sub fields (lacks of the light-on sub fields) halfway of continuous lighting on sub field are different in every lighting steps corresponded to the display grayscale levels of display cells/pixels (the second method, FIG. 12). That is, in the light-on sub fields from the lowest position to the highest position according to the display data, the positions of light-off sub fields that exist in halfway intermittently are different.

Therefore, the sub field ON/OFF states likely differ between cells of the field, and the electric charge states are likely uneven between cells. Accordingly, in order to perform a stable drive, a reset action to make the electric charge states between cells as even as possible is necessary. In the conventional drive control, during the reset period of sub fields, an action to generate a weak discharge (reset discharge) in cells is executed by applying a reset waveform.

Further especially, in the case of the structure where the discharge space and cells are not completely separated by ribs, for example in the structure of only vertical ribs (stripe shaped ribs), the electric charge states between the cells likely become more uneven. Accordingly, as the reset action before address action of respective sub fields, it is necessary to perform a relatively strong reset discharge (FIG. 8, the first reset action).

By the above mentioned reset action, the background emission of the field becomes high by the reset discharge emission, as a result, the contrast is apt to decrease. Although the reset discharge emission is weaker than sustain discharge emission, the background emission increases as much as the reset discharge generated.

Furthermore, according to the selective lighting states of the plurality of sub fields in the conventional sub field lighting pattern, especially, according to the lacks of the lighting sub fields, the false outline occurs.

And, in the conventional field drive control, considerations on the stable drive, in particular, considerations on the drive margin by the reset action have been insufficient. In the case where the reset action is carried out for each sub field, the drive time for that is required. Further, as a conventional art for simplifying the reset action of all normal cells and shortening the drive time, there has been an art of thinning-out reset action to reset only ON cells (FIG. 9, the second reset action).

The present invention has been made in consideration of the above problems in the prior art, and accordingly the object of the present invention is to provide an art for improving the image quality, and stabilizing the drive in a PDP apparatus (multiple grayscale display apparatus), by reducing the unevenness of the electric charge states between cells caused by the sub field lighting pattern and the background emission by the reset discharge, and by reducing the false outline.

The outline of a representative one among the inventions disclosed in this application is briefly explained as below. In order to achieve the above object, the present invention is an art of multiple grayscale display using the sub field method (the sub field conversion, the sub field lighting pattern and a drive method accordingly thereto), and is characterized by comprising means shown below. For example, in a PDP apparatus of an ALIS structure, the present method is used. Hereinafter, the sub field is referred to simply as SF.

The present method and apparatus have the following structure, for example. The present apparatus includes a display panel (PDP, for example) where display cell group and pixel group corresponding thereto are structured by electrodes, and a circuit unit that executes display-driving and control of the display panel, and displays multiple grayscale moving images on the display panel by SF method. In the SF method, the field corresponding to the display area of the display panel is structured in a time-division manner into a plurality (m) of SFs (SF1 to SFm) to which weighting levels from the lowest position to the highest position concerning brightness (luminance) are assigned. According to the display data of input, by the emission time length by the selection of light-on (ON)/light-off (OFF) of the plurality (m) of SFs, moving images by the luminance expression of multiple grayscale (grayscale values or grayscale levels) of pixel group of the field are displayed. The SF lighting pattern regulates the relation between the plurality of lighting steps (s) corresponded to grayscale, and the combination of ON/OFF of the plurality (m) of SFs. According to the display data of input (video signals), in accordance with the SF lighting pattern, by conversion (coding), the display data of output (field and SF data) is generated.

And, in the present method, in the SF conversion and the structure of the SF lighting pattern thereof, a structure, in which for a plurality (typically all) of lighting steps (s) by the above combination, in only one or more (n) specified SFs (SFx) among the plurality (m) of SFs (m>n), intermittent light-off SFs (lack of light-on SF) halfway of continuous light-on SFs (light-on SFs from the lowest position (SFmin) to the highest position (SFmax) corresponding to display data) are permitted, is employed. By utilizing the difference of ON/OFF of the specified SF (SFx), different lighting steps (grayscale) are structured. In the present SF lighting pattern, in consideration of the balance between the securement of the number of grayscale (lighting steps), and the reduction of the false outline, as the specified SFs (SFx), for example, n=2 or 3 pieces among m=10 or more of SFs are arranged.

By the above structure, each cells of the field has a structure where positions of continuous ON SFs and OFF SFs halfway thereof are roughly of the same pattern. Therefore, the unevenness of the electric charge states between cells is reduced. Accordingly, especially the control of the reset action becomes easy, and stable drive can be realized. For example, as for the continuous-ON SF portion in the field, it becomes easy to omit the reset discharge of all cells. In other words, as for the continuous-ON SF portion, it becomes effective to carry out the thinning-out reset action. As much as the omission of the reset discharge, the background emission is reduced. Further, as much as the omission of the reset action, extra room is generated in the drive margin.

Further, it is a structure where the SF selective lighting state is hardly changed between lighting steps of the SF lighting pattern. Especially, in the structure, at the portion lower than the ON SF (SFmax) at the highest position corresponding to the display data, ON/OFF is changed only in the above specified SFs (SFx), and, continuous OFF SF is not arranged. Thereby, as the number of the OFF SF portions is small, the drive is stabilized and the false outline is unlikely to occur.

Furthermore, the present method, in other words, as the structure of SF lighting pattern, the structure where among the plurality (m) of SFs, in only one or more specified SF pairs (adjacent 2 SFs), SF pair where a first SF (SFi) becomes OFF and a next second SF (SFi+1) becomes ON is permitted, is employed.

As the reset action, for example, in the continuous-ON SFs, the reset discharge is not generated (the normal reset action is not carried out), except in the SF at which the continuous-ON is started. Otherwise, except the cell or the pixel at which the continuous-ON is started, the reset discharge is not generated (the thinning-out reset action is carried out).

Further, for example, in order to cope with the number of grayscales larger than the number of the lighting steps (s), frame modulation (SF lighting pattern overlapping method) may be combined. That is, a plurality of the different SF lighting patterns including the SF lighting pattern mentioned above are used in overlap spatially in the field, and thereby grayscale values existing among grayscale values which can be corresponded directly to the lighting steps (s) are expressed.

The effects to be obtained by a representative one among the inventions disclosed in this application are briefly explained as below. According to the present invention, it is possible to reduce the unevenness of the electric charge states between cells by the SF lighting pattern and the background emission by the reset discharge, in a PDP apparatus (multiple grayscale display apparatus), and also reduce the false outline, thereby the image quality can be improved and the drive can be stabilized. Moreover especially, it is possible to secure the drive margin by omitting the reset discharge.

### BRIEF DESCRIPTIONS OF THE DRAWINGS

FIG. 1 is a figure showing the entire structure of a multiple grayscale display apparatus (PDP apparatus) according to one embodiment of the present invention.

FIG. 2 is a disassembled perspective view showing one structure example of a display panel (PDP) in a multiple grayscale display apparatus according to one embodiment of the present invention.

FIG. 3 is a figure showing the structure of a field drive control in a multiple grayscale display apparatus according to one embodiment of the present invention.

FIG. 4 is a figure showing the structure of a first sub field lighting pattern in a multiple grayscale display apparatus according to one embodiment of the present invention.

FIG. 5 is a figure showing the structure of a second sub field lighting pattern in a multiple grayscale display apparatus according to one embodiment of the present invention.

FIG. 6 is a figure showing the corresponding relation of the lighting state change between sub fields and the reset method, as the policy of the reset action in a field drive control, in a multiple grayscale display apparatus according to one embodiment of the present invention.

FIG. 7 is a figure showing an application example of a reset action to each sub fields of a sub field lighting pattern, in a multiple grayscale display apparatus according to one embodiment of the present invention.

FIG. 8 is a figure showing a structural example of drive waveform of a first reset action, in a multiple grayscale display apparatus according to one embodiment of the present invention.

FIG. 9 is a figure showing a structure example of drive waveform of a second reset action, in a multiple grayscale display apparatus according to one embodiment of the present invention.

FIG. 10 is a figure showing the structure of a sub field lighting pattern by binary coding method, in a conventional multiple grayscale display apparatus.

FIG. 11 is a figure showing the structure of a sub field lighting pattern in a first method, in a conventional multiple grayscale display apparatus.

FIG. 12 is a figure showing the structure of a sub field lighting pattern in a second method, in a conventional multiple grayscale display apparatus.

### DESCRIPTIONS OF THE PREFERRED EMBODIMENTS

The embodiments of the present invention is described in more details with reference to the attached drawings hereinafter. Note that, in all the drawings for explaining the embodiments, in principle an identical symbol is assigned to the same component, and repeated explanations thereof are omitted.

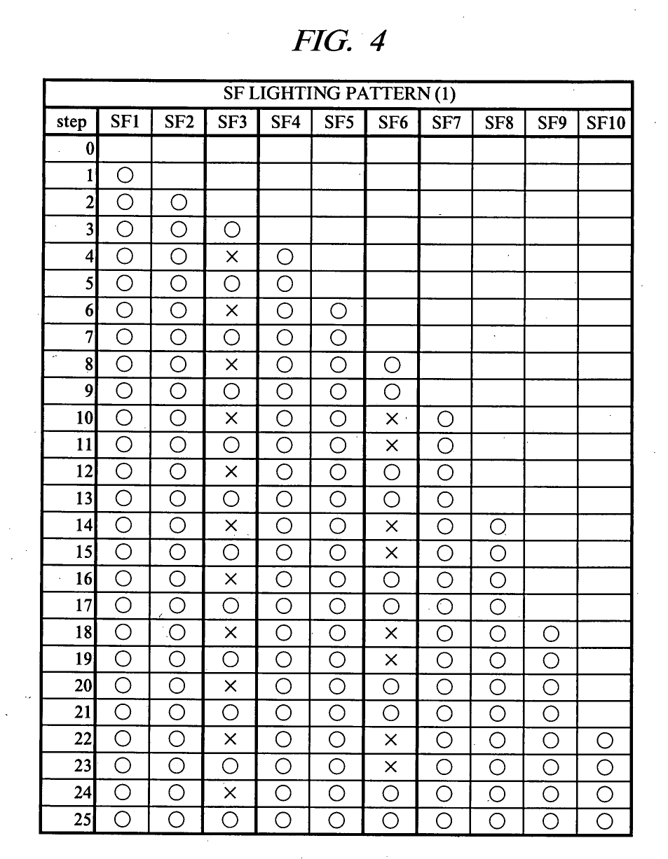

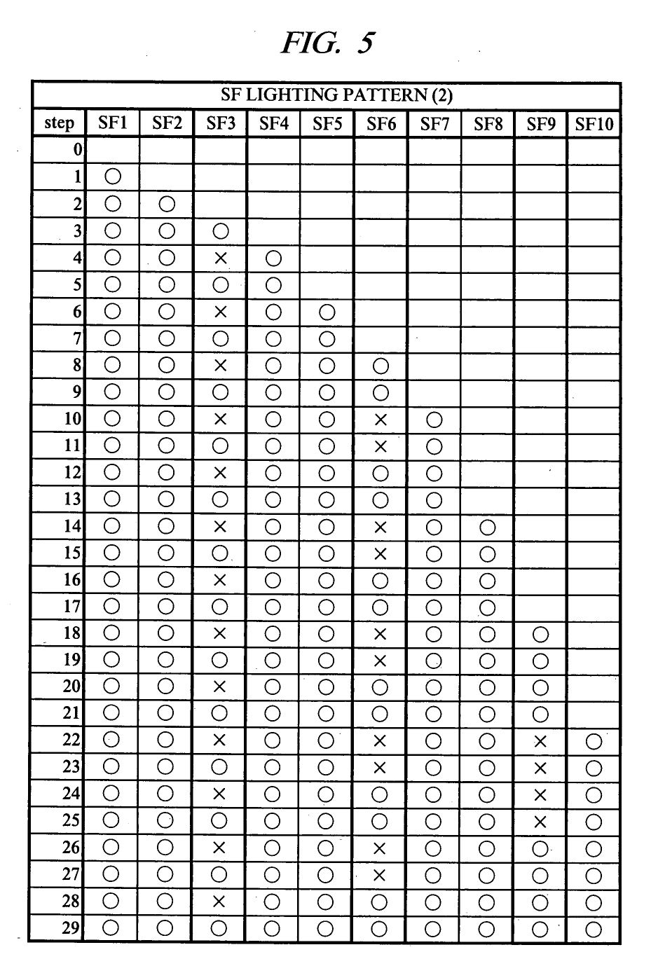

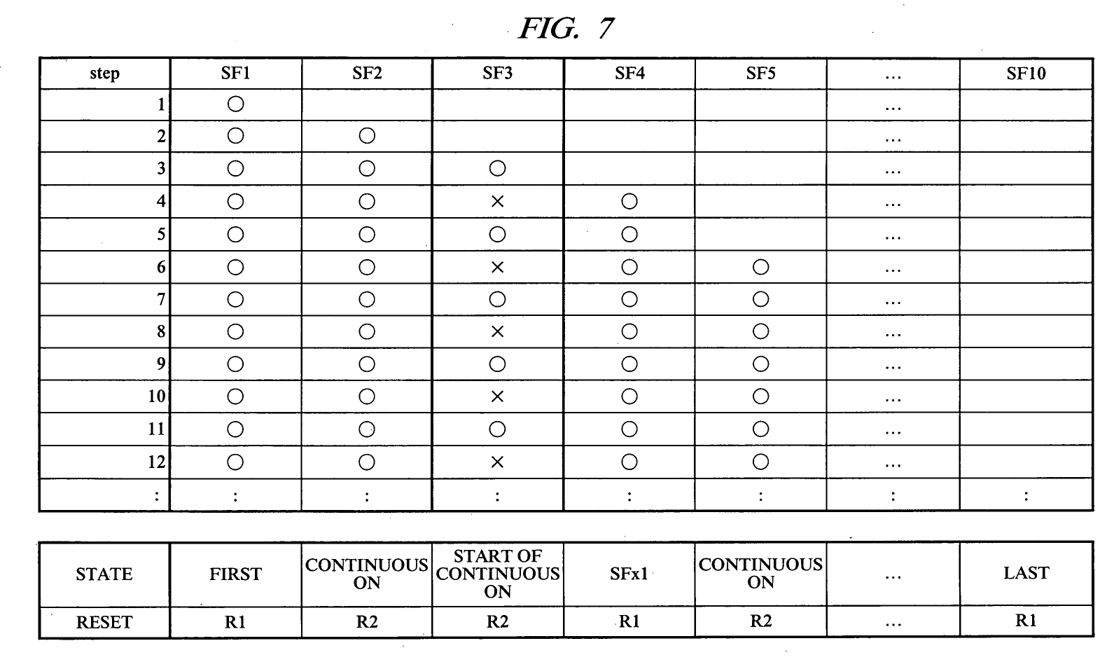

As the outline, a multiple grayscale display method of the present embodiment is applied to a PDP apparatus (multiple grayscale display apparatus) of an ALIS type. In the present method, as shown in FIG. 4, FIG. 5, a structure in which the lacks of light-on SFS are permitted only in a few specified SFS in the SF lighting pattern is employed. In addition, as shown in FIG. 7 and the like, two kinds of reset actions are used selectively according to the lighting state changes between SFs, and thereby the number of the reset discharges is reduced. The characteristics of the present invention are especially effective in the case of the ALIS type.

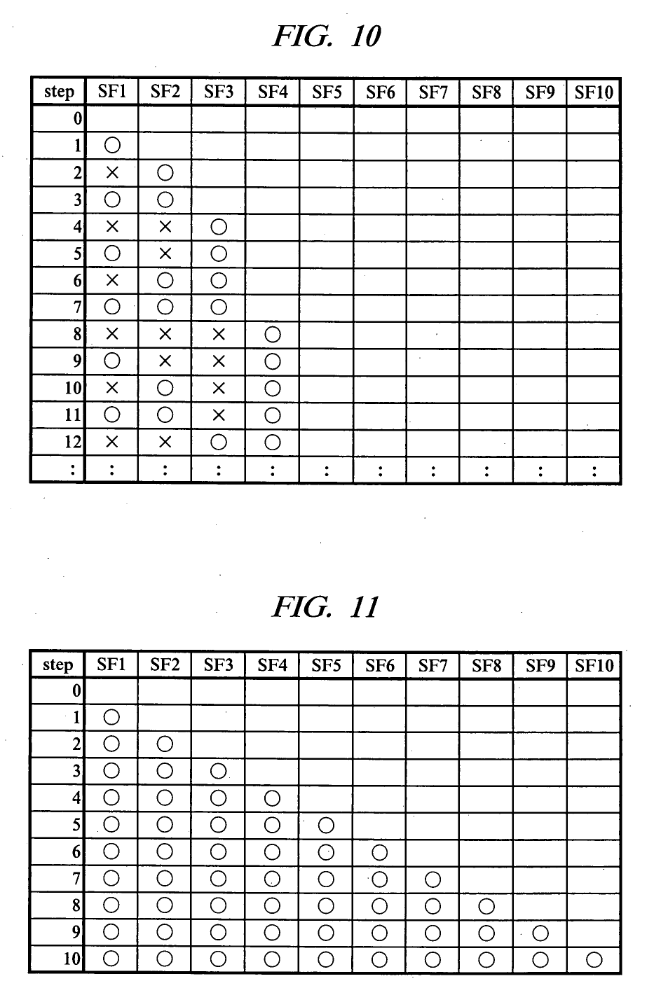

First, the multiple grayscale display methods of the prior art in relation to the present embodiment are briefly explained with reference to FIG. 10 to FIG. 12 hereinafter.

<Prior Art 1>

In FIG. 10, an example of the SF lighting pattern in a simple binary coding method in the prior art is shown. To m=10 pieces of SFs (SF1 to SFm) of the filed, for example, binary weighting such as 1, 2, 4, 8 is given, in order from the bottom, and by their selective lightings, many continuous lighting steps (grayscales) such as 0, 1, 2, 3, 4 are obtained. However, at s=8, for example, the highest position light-on SF (SFmax) goes up from SF3 to SF4, and the continuous light-off state occurs in below SF3, which becomes the source generating a false outline.

<Prior Art 2>

In FIG. 11, an example of the SF lighting pattern in the first method of the prior art is shown. It shows the corresponding relation between the lighting step (s: step), and the ON/OFF selection (combination) of a plurality of SFs (SF1 to SFm) of specified weighting of the field. The present method is a method in which one grayscale is expressed by one SF. The circle shows light-on (ON), and other blanks show light-off (OFF). For example, the field is structured of 10 pieces (m=10) of SFs (SF1 to SF10), and there are 11 pieces of lighting steps (s) 0 to 10. To the lighting steps (s), grayscale values are corresponded. In the present structure, all the lighting SFs from the one at the lowest position (SFmin) to the one at the highest position (SFmax) corresponding to the display data are completely lighted on continuously, and the structure has no lack of lighting SF, therefore, the false outline can be handled effectively. However, the lighting steps (s) and the grayscale values that can be directly expressed are few, and are extremely poor as the grayscale expression. Meanwhile, for the expression of grayscale values between the grayscale values that are directly corresponded to the lighting steps (s), a known error diffusion process and the like are used, nonetheless, in the case of the present method, the grayscale expression is insufficient.

<Prior Art 3>

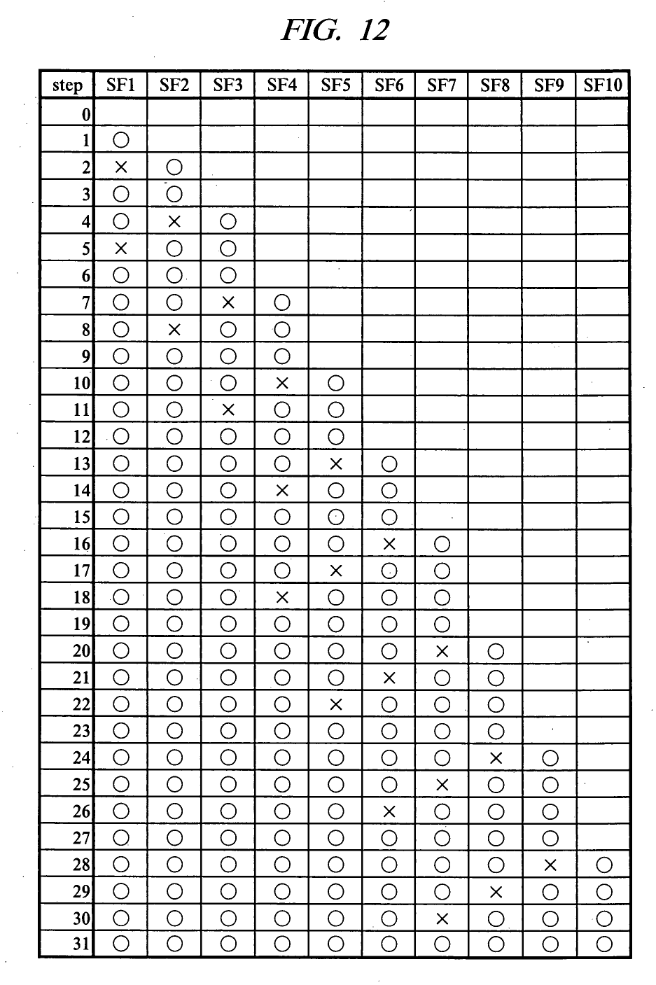

In FIG. 12, an example of the SF lighting pattern in the second method according to the prior art is shown. In the present method, the lighting step (s) is arranged where only one SF halfway from the one at the lowest position (SFmin) to the one at the highest position (SFmax) corresponding to the display data is off (lack). The x-mark portion indicates especially the lack of lighting SF among light-off (OFF). For example, in 10 pieces (m=10) of SFs (SF1 to SF10) of the field, there are 32 pieces of lighting steps (s) from 0 to 31. At s=7, for example, in roughly continuous ON state from SF1 at the lowest position (SFmin) to SF4 at the highest position (SFmax), halfway, only SF3, one position below, is in OFF state. In addition, for example at s=8, SF2 is a lack. In the same manner, in a plurality of lighting steps, the SF positions where the lack of lighting SF exists are different. In the second method, the lighting steps (s) increase in comparison with the first method and is advantageous for the grayscale expression, but the portion of the lack of lighting SF becomes the source generating a false outline.

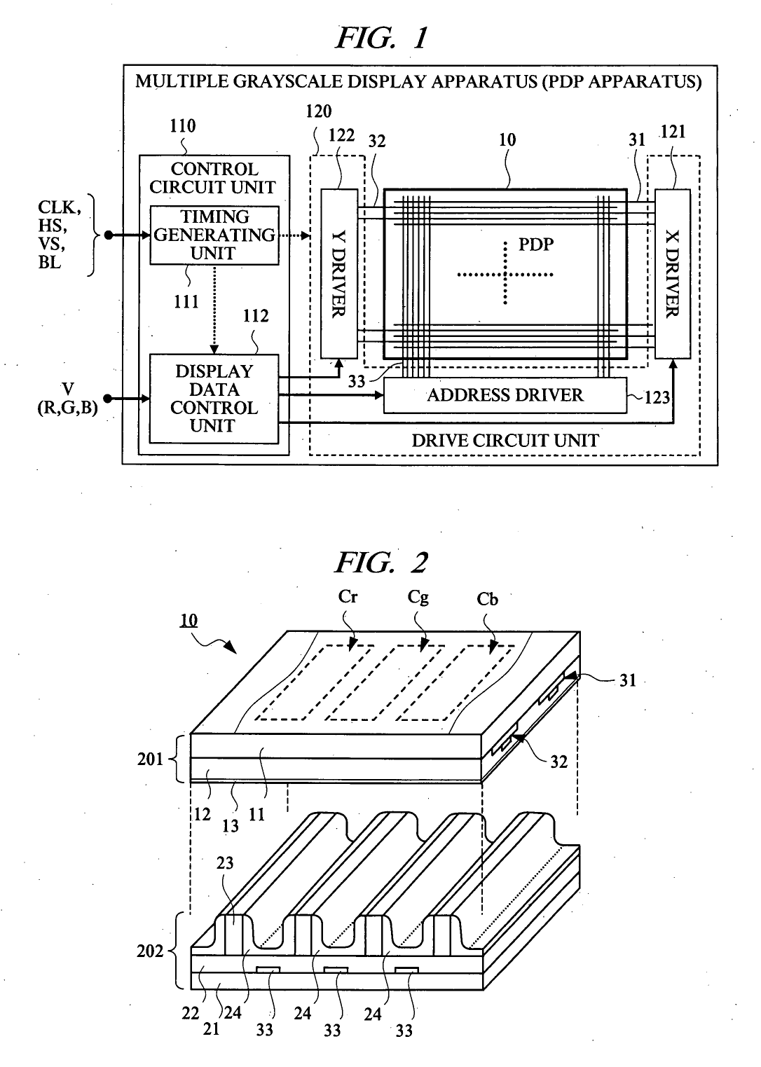

Next, the basic structure of a PDP apparatus of the present embodiment is explained with reference to FIG. 1 to FIG. 3 hereinafter.

<PDP Apparatus>

In FIG. 1, the present PDP apparatus has a structure comprising a display panel (PDP) 10, a control circuit unit 110, and a drive circuit unit 120 and the like. The control circuit unit 110 controls the entire PDP apparatus including the drive circuit unit 120 and the like, and the drive circuit unit 120 drives and controls the display panel 10. The control circuit unit 110 includes a timing generating unit 111 and a display data control unit 112 and the like. The drive circuit unit 120 includes an X driver 121, a Y driver 122, and an address driver 123 and the like. Each circuit units are implemented on an IC substrate or the like, and are electrically connected with electrode group of the display panel 10.

The timing generating unit 111 inputs a control clock signal (CLK), a horizontal synchronize signal (HS), a vertical synchronize signal (VS), a blanking signal (BL) and the like, and generates and outputs a timing signal necessary to control the display data control unit 112 and the drive circuit unit 120 and the like.

The display data control unit 112 generates and outputs display data (field and SF data) for video display by multiple grayscale pixel group to the display panel 10 and the drive circuit unit 120 by a multiple grayscale display processing (SF conversion processing), on the basis of input video signal (V). In the memory in the control circuit unit 110, the display data and the like are stored.

The input video signal (V) is signal/data including, for example, information of grayscale values of (R, G, B) format. The field and SF data is data coded to the ON/OFF information of each cell of each SF, corresponding to the information of grayscale values.

Further, in the control circuit unit 110, data and setting of the SF lighting pattern to be described later are also held as control data/information. In the display data control unit 112, the SF conversion processing is carried out using them.

The display data control unit 112 outputs the SF data of the field and the control signal and the like, at every field display timing, to the drive circuit unit 120. Thereby, the drive circuit unit 120 outputs a voltage waveform for display drive to the electrode group of the display panel 10. Thereby, the electrode group of the display panel 10 are driven, and discharge occurs in the display cell group, and the field display is executed.

The display panel 10 is, for example, a PDP of an AC type 3-electrode structure, including an X electrode 31 and a Y electrode 32 for generating the display sustain discharge, and an address electrode 33 for address action. The Y electrode 32 is used also for scan action.

In the drive circuit unit 120, the X driver 121 drives X electrodes 31 of the display panel 10 by applying voltage. In the same manner, the Y driver 122 drives Y electrodes 32. The address driver 123 drives address electrodes 33.

<PDP>

In FIG. 2, an example of the panel structure of the PDP 10 is explained. It shows a part corresponding to pixels. In the PDP 10, structure bodies (front surface unit 201, back surface unit 202) of a front substrate 11 and a back substrate 21 mainly composed of light emitting glass are assembled to face each other, and the peripheral portion thereof is sealed, and discharge gas is filled in the space.

In the front surface unit 201, on the front substrate 11, a plurality of X electrodes 31 and Y electrodes 32 expand in parallel in the lateral (row) direction and formed repeatedly alternately in the longitudinal (column) direction. The electrodes (display electrodes) is covered with a dielectric layer 12 and further the surface thereof is covered with a protective layer 13.

In the back surface unit 202, on the back substrate 21, a plurality of address electrodes 33 expand in parallel in the direction roughly orthogonal to the X electrodes 31 and the Y electrodes 32, and further they are covered with a dielectric layer 22. On the dielectric layer 22, on both sides of the address electrodes 33, ribs 23 expanding in the longitudinal direction are formed, and divided in the column direction. Further, between the ribs 23 of discharge spaces, on the dielectric layer 22 on the address electrodes 33, a fluorescent material 24 that emits visible light of red (R), green (G), and blue (B) excited by ultraviolet ray is applied.

Display rows are structured in correspondence to pairs of adjacent respective X electrodes 31 and Y electrodes 32, further, display columns and cells are structured in correspondence to crossing with the address electrodes 33. In the ALIS type, the Y electrodes 32 are used in common in adjacent rows. A pixel is structured by the set of R, G, B cells (Cr, Cg, Cb). The display area of the PDP 10 is structured by rows and columns of cells (pixels), and is corresponded to fields and SFs to become video display units. The PDP has various structures according to drive methods and the like.

<Field and SF>

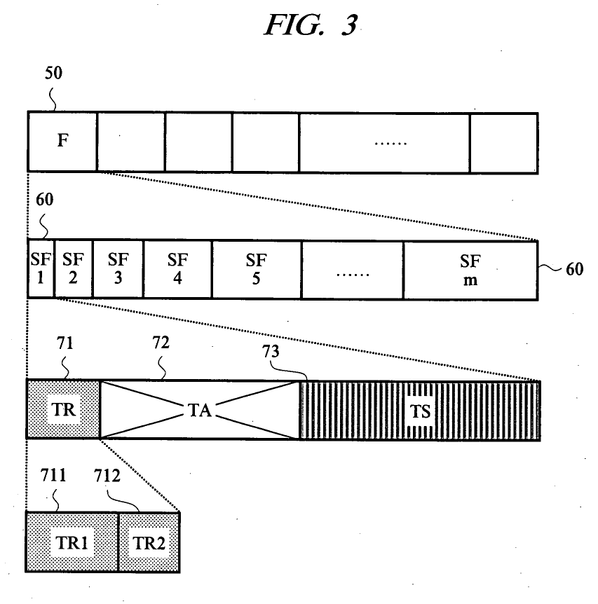

In FIG. 3, as the basic of the drive control of the PDP 10, the structure of the field and SF is explained. One field (F: field period) 50 is displayed by 1/60 second, for example. The field 50 is structured of a plurality (m) of SFs (sub field periods) 60 divided in time manner for grayscale expression. Each of the SF (SF1 to SFm) 60 is structured to have a reset period (TR) 71, an address period (TA) 72, and a sustain period (TS) 73. The SF 60 of the field 60 is assigned weighting by the length of the sustain period (TS) 73 (in other words, the number of sustain discharge times), and by the selection (combination) of light-on (ON)/light-off (OFF) of these SFs (SF1 to SFm) 60, the grayscale of pixels is expressed.

In the reset period (TR) 71, a reset action is carried out to make the electric charge states of cells of the SF 60 even as much as possible for preparation of the action of the next address period 72. In the next address period (TA) 72, the address action to select cells of ON/OFF in cell group of the SF 60 is carried out. That is, according to the display data, scan pulse is applied to the Y electrodes 32, and address pulse is applied to the address electrodes 33, thereby address discharge is generated in cells to light-on (in the case of write address method). In the next sustain period (TS) 73, the sustain action is carried out in the cells selected in the address period (TA) 72 just before it, sustain pulse is applied repeatedly to pairs of X electrodes 31 and Y electrodes 32, and thereby sustain discharge is generated and emission display is performed.

Next, in the basic structure explained above, with reference to FIG. 4, FIG. 5 and the like, the characteristics of the multiple grayscale display method according to the present embodiment and the PDP apparatus using the same are explained.

<SF Lighting Pattern 1>

In FIG. 4, a first SF lighting pattern used in the present embodiment is shown. In the first SF lighting pattern, a pattern structure in which, in a plurality of lighting steps (s), light-off SF (lack of light-on SF) is permitted, in only two specified SFs (SF3, SF6), halfway of the continuous lighting SFs from the lowest position (SFmin) to the highest position (SFmax) according to display data, is employed. The positions of the specified SFs is the positions where ON/OFF mainly changes. The x-mark portion shows especially, the lack of lighting SF, of light-off (OFF). In the present example, specified SFs (SFx) are (SFx1=SF3, SFx2=SF6). For example, in m=10 pieces of SFs (SF1 to SFm) of the field, 26 pieces of lighting steps (s) 0 to 25 are structured.

At s=0 to 3, lighting step is structured in every one SF (SF1, SF2, SF3). At s=4, 5, with the lighting SF at the highest position (SFmax) going up to SF4, two lighting steps are structured by the difference of ON/OFF of SF3. At s=4, OFF exists in SF3, and at s=5, ON exists in SF3. In the same manner, at s=6, 7, as SFmax goes up to SF5, two lighting steps are structured by the difference of ON/OFF of SF3. In the same manner, at s=8, 9, as SFmax goes up to SF6, two lighting steps are structured by the difference of ON/OFF of SF3. Thereafter in the same manner, different structures are structured by repetition of ON/OFF of SF3 per lighting step.

Further, at s=10, 11, 12, 13, in addition to the ON/OFF of SF3, by the combination with ON/OFF of SF6, different lighting steps are structured. That is, at s=10, 11, as SFmax goes up to SF7, two lighting steps are structured by OFF of SF6, further at s=12, 13, in the same manner, SFmax is SF7, and two lighting steps are structured by ON of SF6. Further, at s=14 to 17, as SFmax goes up to SF8, by the same combination as s=10 to 13 in SF7 and below, four lighting steps are structured. In the same manner, at s=18 to 21, SFmax is SF9, and by the same combination as s=14 to 17 in SF8 and below, four lighting steps are structured. In the same manner, at s=22 to 25, SFmax is SF10, and by the same combination as s=18 to 21 in SF9 and below, four lighting steps are structured.

Thus, in the plurality (26 pieces) of lighting steps (s=0 to 25), the position where the lack of the lighting SF is permitted is limited only to SFx (SF3, SF6). According to the structure using the present pattern, in each cell of the field, the positions of the continuous lighting SFs and light-off SFs halfway thereof become roughly of the same pattern. Accordingly, the unevenness of electric charge states among cells is reduced. Thereby, the stable drive can be obtained, for example, it becomes easy to omit the reset discharge. Furthermore, in the structure, between lighting steps (especially adjacent or near lighting steps), the change of SF selective lighting states is small. Especially, from SFmin to SFmax, ON/OFF is changed only in SFx, and, continuous OFF SF is not arranged below SFmax. Thereby, as the number of OFF SF portions is small, the drive is stabilized, and false outline is unlikely to occur.

Further, in the present structure, in unit of SF pair (SFi−SFi+1), among all the SFs in the field, only in two specified SF pair portions (SF3-SF4, SF6-SF7), an SF pair where a certain SFi is OFF and the next SFi+1 is ON is permitted.

<SF Lighting Pattern 2>

Next, in FIG. 5, a usable second SF lighting pattern is shown. In the second SF lighting pattern, in a plurality of lighting steps (s), in only three specified SFs (SF3, SF6, SF9) from SFmin to SFmax, light-off SF (lack of light-on SF) is permitted. It is SFx (SFx1=SF3, SFx2=SF6, SFx3=SF9). For example, in m=10 pieces of SFs (SF1 to SF10), 30 pieces of lighting steps (s) 0 to 29 are structured. The selective lighting states of SF1 to SF8 and the portion of s=0 to 21 in the second SF lighting pattern are same structure as those in the first SF lighting pattern.

At s=22 to 29, in addition to ON/OFF of SF3, SF6, by the combination with ON/OFF of FS9, different lighting steps are structured. That is, at s=22 to 25, as SFmax goes up to SF10, four lighting steps are structured by OFF of SF9, and further at s=26 to 29, in the same manner, SFmax is SF10, and four lighting steps are structured by ON of SF9. Thus, by increasing SFx, the number of lighting steps can be increased.

Like the above first, second SF lighting patterns, in consideration of the balance between the grayscale expression and the false outline reduction, a specified SF lighting pattern is set and used.

<Reset Action>

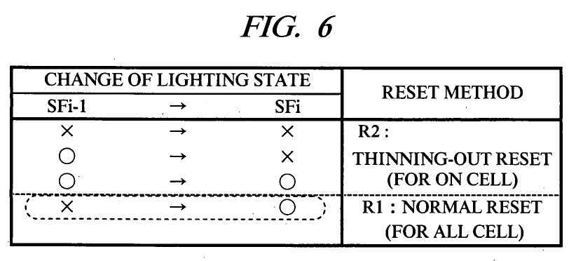

Next, with reference to FIG. 6 to FIG. 9 and the like, the control of reset action in the field drive control, executed with the above SF lighting pattern and the SF conversion structure, in the present embodiment, is explained hereinafter. As the outline, corresponding to each SF of the field, the presence or absence of the normal reset action is set. In other words, different reset action is carried out according to SF. In the present example, R1: a first reset action (normal reset), and R2: a second reset action (thinning-out reset) are used. The first reset action is a reset discharge action to all cells. The second reset action is a reset discharge action to ON cells. Note that, ON cells mean the cells in the light-on (ON) state in the previous SF (sustain discharge state), and OFF cells mean the cells of the light-off (OFF) state in the previous SF (non sustain discharge state).

As mentioned previously, in a plurality of lighting steps, the positions of lacks of lighting SF are of the same pattern. Accordingly, with regard to the continuous ON SF portion of the field, it is easy to omit the reset discharge by the first reset action. That is, the unevenness of electric charge states between cells in SF is small, and there is low necessity to generate the reset discharge securely, therefore, the thinning-out reset action becomes effective. By the omission of the reset discharge, the background emission is reduced. Further, by the omission of the reset action, there occurs extra room in the drive margin.

<Reset Basic>

In FIG. 6, as the basic policy of the reset action, the corresponding relation between the lighting state changes between continuous SFs, and the preferable selection of a reset method according to that is shown. In four kinds of ON/OFF changes of the foregoing SF (SFi−1) and the current SF (SFi), in the case where SFi−1 is OFF and SFi is ON, it is preferable to use R1: normal reset. In other cases, it is preferable to use R2: thinning-out reset.

In order to light at the current SF on the light-off cell at the foregoing SF (OFF cell), reset discharge of electric charge write is securely generated in the cell concerned by the waveform (to be described later herein) of the first reset action.

<Reset Action per SF>

In FIG. 7, on the basis of the above policy, an example of the reset action to each SF of the field is shown. In the present example, in the first and last SFs of the field (SF1, SF10), and the SF at which continuous lighting is started (example: SF4), the first reset action (R1) is carried out, and in other SFs (SF2, SF3, SF5, . . . ) including the specified SF (SFx), the second reset action (R2) is carried out (or may be selectable).

In the first SF1 and the last SF10 of the field, and the SF at which continuous ON is started just after SFx, the reset discharge by R1 is generated securely. In other SFx and continuous ON SF, the necessity of the reset discharge by R1 is low, and accordingly, it is effective to omit the reset discharge by R2.

<Reset Waveform R1>

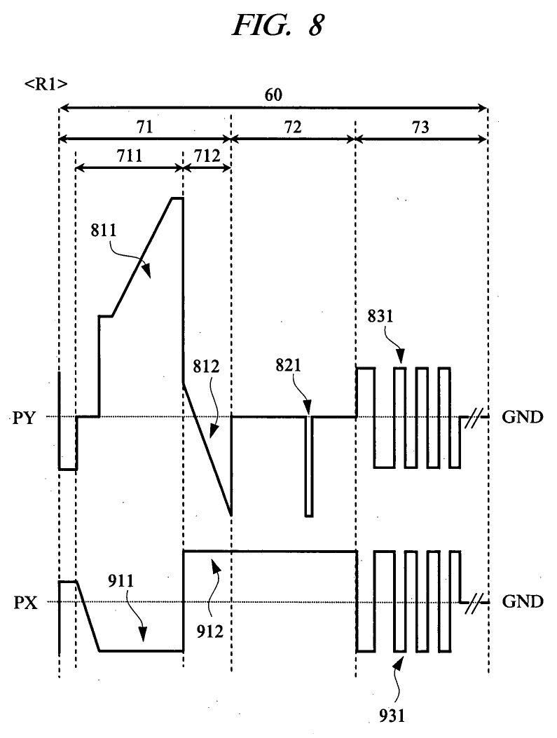

In FIG. 8, an example of the drive waveform of the first reset action (R1) is shown. In the first reset action (R1), the reset discharge is generated in all cells. PY, PX are waveforms applied to the Y electrode 32 and the X electrode 31.

In the reset period 71, in the first reset waveform, to the pairs of the X electrodes 31-Y electrodes 32 of all cells of the SF concerned, electric charge write waveforms (positive dull wave 811 of Y electrodes 32 and negative voltage 911 of X electrodes 31) at the first period 711, and electric charge adjust waveform (negative dull wave 812 of Y electrodes 32 and positive wave 912 of X electrodes 31) at the second period 712 are applied. Thereby, especially write discharge by the waveforms (811, 911) of the first period 711 is generated between X electrodes 31 and Y electrodes 32. The emission by this discharge is smaller than the emission of sustain discharge, but it becomes the background brightness.

In the address period 72, by applying scan pulse 821 to the objective Y electrodes 32, and applying address pulse to the objective address electrodes 33, address discharge is generated in selected cells. In the sustain period 73, by applying pair of polarity inverted repeated sustain pulses (831, 931) to all X electrodes 31-Y electrodes 32, the number of sustain discharges corresponding to the SF weighting are generated in selected cells.

<Reset Waveform R2>

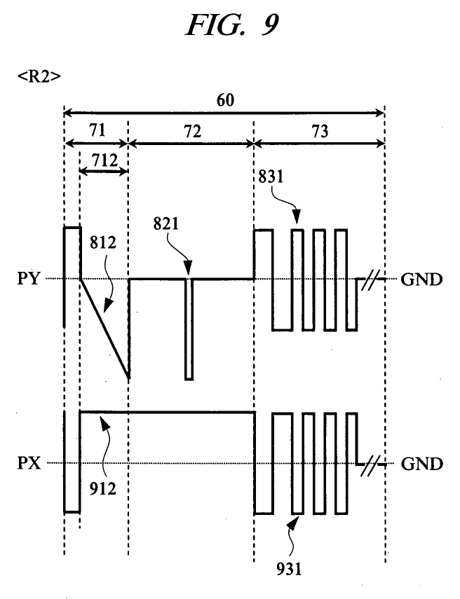

In FIG. 9, an example of the drive waveform of the second reset action (R2) is shown. In the second reset action, reset discharge is generated only in ON cells.

In the reset period 71, as a second reset waveform, to X electrodes 31-Y electrodes 32 of all cells of the SF concerned, electric charge adjust waveform (negative dull wave 812 of Y electrodes 32 and positive voltage 912 of X electrodes 31) at the second period 712, in which, electric charge write waveform (positive dull wave 811 of Y electrodes 32 and negative voltage 911 of X electrodes 31) at the above first period 711 is thinned-out, is applied. Thereby, the write discharge shown above does not occur, and the reset discharge occurs only in ON cells.

As the effect of this action, since there is no discharge by the reset action, especially no electric charge write discharge, the emission to become the background brightness is suppressed accordingly, and the contrast is improved. Further, the drive time can be shortened accordingly, which lead to stable drive. Furthermore, since the SF OFF portions are reduced, the address action time can be reduced, and extra room is generated in the drive margin. If extra room exists in the drive margin, it is possible to increase the sustain action time, for example.

As described above, according to the present embodiment, by the SF lighting pattern and the SF conversion structure in consideration of the grayscale expression (securing the number of lighting steps) and the false outline occurrence source reduction, it is possible to reduce the background emission and the false outline, further, to stabilize the drive by omission of reset discharge and the like.

The invention made by the present inventors has been explained in concrete on the basis of the embodiments, and it may be well understood by those skilled in the art that the present invention is not limited to the embodiment mentioned above, but may be embodied by appropriately modifying the structural components thereof without departing from the spirit or essential characteristics thereof.

The present invention can be applied to a multiple grayscale display apparatus such as a PDP apparatus and the like.

What is claimed is:

1. A multiple grayscale display method,
wherein a field of a display panel on which display cell group and pixel group corresponding thereto are structured by electrodes is structured in a time-division manner into a plurality (m) of sub fields to which weighting levels from the lowest position to the highest position concerning brightness are assigned, and according to display data of input, by emission time length by selection of light-on/light-off of the plurality (m) of sub fields, moving images by multiple grayscale expression of the pixel group of the field are displayed, and as a structure of sub field lighting pattern that regulates a relation between combination of ON/OFF of the plurality (m) of sub fields and lighting steps corresponded to grayscale, a structure in which only in one or more (n pieces of) specified sub fields among the plurality (m pieces) of sub fields (m>n), light-off in halfway of continuous light-on from the lowest position to the highest position corresponding to display data are permitted for a plurality of lighting steps, is employed.

2. The multiple grayscale display method according to claim 1,
wherein the number (n) of the specified sub fields among the plurality (m) of sub fields is 2 or 3.

3. The multiple grayscale display method according to claim 1,
wherein in a structure of the sub field lighting pattern, among the plurality of lighting steps, at a sub field lower than a light-on sub field at the highest position corresponding to the display data, ON/OFF is changed only in the specified sub fields, and continuous light-off is not arranged.

4. The multiple grayscale display method according to claim 1,
wherein as a reset action in the plurality (m pieces) of sub fields, in continuously lighting sub fields, except a sub field at which the continuous lighting starts, a reset discharge is not generated or at least a part thereof is omitted.

5. The multiple grayscale display method according to claim 4, comprising:
a period and action of reset, address, and sustain as display drive of the sub fields,
wherein as the reset action in the plurality (m pieces) of sub fields, a first reset action generating reset discharge to all display cells of the field is executed in a first kind of sub fields including a first sub field whose weighting level is lowest (SF1), a last sub field whose weighting level is highest (SFm), and a sub field at which the continuous lighting starts, and
wherein a second reset action in which at least a part of the first reset action is omitted is executed in a second kind of sub fields other than the first kind of sub field.

6. The multiple grayscale display method according to claim 5,
wherein the first reset action is an action to apply drive waveforms using a dull wave for writing electric charge and a dull wave for adjusting electric charge, for generating reset charge to all display cells of the field, and
wherein the second reset action is an action to apply drive waveforms in which the dull wave for writing electric charge is omitted.

7. The multiple grayscale display method according to claim 1,
wherein grayscale values existing among grayscale values corresponded directly to the lighting steps is expressed using plurality of kinds of sub field lighting patterns including sub field lighting pattern using the specified sub fields overlapped spatially in the field.

8. A multiple grayscale display method,
wherein a field of a display panel on which display cell group and pixel group corresponding thereto are structured by electrode group is structured in a time-division manner into a plurality (m pieces) of sub fields to which weighting levels from the lowest position to the highest position concerning brightness are assigned, and according to display data of input, by emission time length by selection of light-on (ON)/light-off (OFF) of the plurality (m pieces) of sub fields, moving images by luminance expression of multiple grayscale of pixels of the field are displayed, and
wherein as a structure of a sub field lighting pattern that regulates a relation between combination of ON/OFF of the plurality (m pieces) of sub fields and lighting steps corresponded to grayscale, a structure in which only in one or more specified sub field pairs among the plurality (m pieces) of sub fields, a sub field pair in which a first sub field (SFi) is OFF and a next second sub field (SFi+1) is ON is permitted for plural lighting steps is employed.

9. A multiple grayscale display apparatus, comprising:
a display panel on which display cell group and pixel group corresponding thereto are structured by electrode group; and
a circuit unit that displays/drives and controls the display panel,
wherein a field of the display panel is structured in a time-division manner into a plurality (m) of sub fields to which weighting levels from the lowest position to the highest position concerning brightness are assigned,
wherein moving images by multiple grayscale brightness expression of the pixels of the field are displayed by emission time length by selection of light-on light-off of the plurality (m) of sub fields according to display data of input,
wherein the display panel includes X electrodes for sustain, and Y electrodes for sustain scan repeatedly arranged alternately to expand in a first direction, address electrodes expanding in a second direction, and ribs expanding in the second direction and separating discharge spaces, and
wherein as a structure of a sub field lighting pattern that regulates a relation between combination of ON/OFF of the plurality (m pieces) of sub fields and lighting steps corresponded to grayscale, a structure in which only in one or more (n pieces of) specified sub fields among the plurality (m pieces) of sub fields (m>n), light-off in halfway of continuous light-on from the lowest position to the highest position corresponding to display data are permitted for plural lighting steps, is employed.

10. The multiple grayscale display apparatus according to claim 9,
wherein as a reset action in the plurality (m pieces) of sub fields, in continuously lighting sub fields, except a sub field at which continuous lighting starts, a reset discharge is not generated or at least a part thereof is omitted.

11. A multiple grayscale display method in which one field is divided into a plurality of sub fields, and images are displayed by controlling light-on and light-off of respective sub fields composing the plurality of sub fields,
wherein light-off subfields turned off before a last light-on subfield turned on the last in time in the one field are one or more predetermined sub fields among the plurality of sub fields.

12. The multiple grayscale display method according to claim 11,
wherein the predetermined sub fields are not continuous for 2 or more in time.

13. The multiple grayscale display method according to claim 11,
wherein a subfield just before the predetermined subfield in time is turned on.
